(19) United States
(12) Patent Application Publication
(10) Pub. No.: US 2026/0178008 A1
(43) Pub. Date: Jun. 25, 2026

(54) EVENT-DRIVEN LARGE-SYSTEM ANALYSIS FOR INDUSTRIAL EQUIPMENT SIGNALING

(71) Applicant: Caterpillar Inc., Peoria, IL (US)

(72) Inventors: Jason P. Clow, Pekin, IL (US); Mayank Minglani, Arlington Heights, IL (US); Soham Chakraborty, West Bengal (IN); Akul Rishi, Chicago, IL (US); Matthew D. Fletcher, Canton, IL (US)

(21) Appl. No.: 18/988,565

(22) Filed: Dec. 19, 2024

(51) Int. Cl. G05B 19/409

(52) U.S. Cl. CPC G05B 19/409; G05B 2219/32128

(57) ABSTRACT

Disclosed herein are techniques for signal control in industrial equipment. A system can acquire signal data regarding a data event detected in connection with operating an industrial machine. The system can route the signal data to a downstream computing system, buffer at least a portion of the signal data in the at least one memory, and use the buffered portion of the signal data to generate a signal control graph. The graph can include a set of nodes connected by a weighted edge. The system can use the buffered portion of the signal data to determine a weight of the weighted edge, set a display property of the weighted edge based on the determined weight, and generate and display a graphical user interface comprising the directed graph, wherein the weighted edge is formatted for display according to the display property.

### BACKGROUND

The term “industrial equipment” refers to heavy-duty machinery that can be used in manufacturing, construction, or other industrial settings. Industrial equipment can include a wide range of machines, such as conveyors, generators, excavators, forklifts, boilers, and other equipment. Industrial equipment can be equipped with on-board or off-board sensors that can generate signals, such as control commands and responses thereto, equipment operating states, equipment fault events, equipment attachment statuses, and/or equipment utilization. Other entities, such as dealers and/or maintenance facilities, can generate additional data regarding industrial equipment, including maintenance event data, inspection data, lease data, application data and/or location monitoring data.

### BRIEF DESCRIPTION OF THE DRAWINGS

Detailed descriptions of implementations of the present invention will be described and explained through the use of the accompanying drawings.

FIG. 1 shows an example ecosystem for industrial equipment signaling.

FIG. 2A shows an example signal control unit for industrial equipment signaling and an example signal analysis unit for event-driven large-system analysis.

FIG. 2B shows example sources of latency in a multi-hop signal control unit.

FIGS. 3A and 3B show example signal control graphs generated by the signal analysis unit.

FIG. 4 shows an example set of expandable nodes and edges in a signal control graph.

FIGS. 5, 6, and 7 show example user interfaces accessible using interactive components of the signal control graph.

FIG. 8 is a flowchart showing a method of signal control in industrial equipment.

FIG. 9 is a block diagram that illustrates an example of a computer system in which at least some operations described herein can be implemented.

FIG. 10 is a system diagram illustrating an example environment in which the platform operates in some implementations.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

In computer-based control ecosystems that include industrial equipment, sensor readings and other data can be propagated across various entities. For example, signals can carry data in the form of physical quantities or impulses used to transmit the data from one computing entity to another. Examples of signals include electrical signals in wires, radio waves in the air, and/or light pulses in optical fibers. Data can be encoded into a signal in a way that allows the data to be accurately transmitted and reconstructed at the receiving end. Data signals can include payload (e.g., items from which the sensor values can be extracted or decoded) and metadata (e.g., signal address information, signal routing information, signal control information, signal sequencing information).

In modern industrial equipment ecosystems, signal processing platforms can include a high number of (e.g., hundreds, thousands, tens of thousands or more) signal processing pipelines. Pipelines can be thought of as connected sets of computing modules or entities that, collectively, implement signal routing logic and can receive, transform, and propagate signals. Signal processing pipelines can subscribe to, for example, data change events, which can occur every second, from various data sources. Data change events can include, for example, sensor readings and/or operating condition changes for equipment modules or attachments, such as brake activation, steering mode activation, gear shift, control activation, attachment activation, and so forth. Data change events can include commands to operate the equipment, events detected at or in connection with operating the equipment, or events detected in the operating environment of the equipment.

Signal processing pipelines can perform signal routing and transformation, apply quality rules, apply tuning rules and/or write, to one or more target data event channels, a large set of electronic messages, which can result in a very high number of executions. As used herein, the term “execution” refers to a particular signal or group of signals' flow through a signal processing pipeline from a source module through one or more additional modules. Source and/or downstream modules in an example signal processing pipeline can include, for example, sensors, powertrain control modules, brake control modules, door control units, speed control units, transmission control modules, battery management systems, telematics control units, and so forth.

Determining lineages of data events and tracing live execution of such pipelines is not always possible. For example, determining lineages of data events can involve tracing of a signal or its derivatives (modified or aggregated sensor readings) throughout an execution. Conventional systems do not always capture or generate signal elements sufficient to identify a particular signal throughout its lifecycle. For example, an attachment on a particular industrial machine can include a set of positioning sensors. Data reported by positioning sensors can be transmitted to an on-board controller unit, which can use the data to generate and transmit, to a remote server, real-time attachment positioning information calculated at the on-board controller using the sensor values. Identifying information regarding the source sensors can be omitted from transmissions to downstream systems, which can make troubleshooting data errors difficult because downstream systems may not be able to determine whether a particular error originated at the on-board controller during the on-board computation or at a particular positioning sensor during data capture.

To take this example further, an aggregation server, downstream of the telematics server, can aggregate fleet control signals for a set of machines in a fleet. For example, a set of tandem excavators can work together to lift a load in a coordinated manner, and positioning information can be captured and aggregated for more than one machine in the set. When signals are aggregated, it can become difficult to identify a true source of error in measurement. For example, if the tandem excavators include sensors and/or circuitry for measuring load properties and the measurements are aggregated to determine a particular load property, such as load positioning or weight, the aggregation operations may discard or omit identifying information for the machine that provided the source data.

In multi-hop signal transmission, various sources of signal latency can include sensors, on-board controllers, telematics servers, data aggregation servers, and downstream applications or communication channels therebetween. One type of latency is wait time latency. Wait time latency refers to the amount of time it takes for a system to respond to a request or perform a task after the request has been made. It is a measure of the delay or lag experienced while waiting for a system to complete an operation. In the context of computing and networking, wait time latency can impact the performance and responsiveness of applications and services. Another type of latency is workload time latency, which is influenced by processing capabilities of a node. Yet another type of latency is propagation latency, which is a time it takes for a signal to propagate from the source to the destination. Propagation latency measures can include queuing latency, which is influenced by the congestion and queuing policies at the nodes. The ability to identify various types of latency is important for optimizing performance of multi-hop systems for industrial equipment signal processing.

To solve these technical problems, disclosed herein are systems and processes to intercept and process industrial equipment control signals. Described herein are techniques to extract artifacts that describe signal control processes and the subscribing and published data events into a graph that can include nodes an edges. A directed graph, also known as a digraph, is a type of graph in which edges have a direction. This means that the connections between nodes have a specific direction, indicating that there is a one-way relationship between the nodes. Each edge in a directed graph has an associated source and target node, showing the direction of the relationship between the nodes.

Nodes in a graph represent pipeline artifacts, which can include datasets and pipelines, also sometimes referred to as signal paths, signaling paths, pipeline execution paths, or physical event channels (e.g., software, hardware, processors, memory, communication channels, servers, databases that collectively comprise a channel). A data pipeline artifact can include zero to many subscriptions to a dataset, along with one or more target datasets. The nodes can have descriptive attributes that can include signal identifying information sufficient to identify a particular signal throughout its lifecycle. The attributes can include flags, information, or identifiers that describe the data domain, versioning, and/or technology as well as node latency values (e.g., workload time latency, queuing latency). Accordingly, a dataset can define various attributes, which can be generated by extracting and processing corresponding signal data. The attributes can capture latency values (e.g., in milliseconds), such as propagation latency for real-time channels and physical event channels. Edges in a graph can define the relationships of subscriptions, targets, data access controls, routing information and so forth.

The signal analysis techniques described herein can be applied to the artifacts (nodes and edges in a graph) which describe process execution during tracing events, including live tracing events. In some implementations, graphs can be enriched with edge weights calculated based on the number of process executions in the timeframe under analysis. Visualizations can be applied to the node and edge collections to enable interactive traversal of graphs. Visualizations can enable users to expand/contract relationships of interest or disinterest. In some implementations, graphs can include interactive controls to enable users to rerun executions or expire pending executions. In some implementations, the system can enable administrators to visualize latency-related metrics, identify performance bottlenecks, and make adjustments to related system controls.

As used herein, the term “set” refers to a physical or logical collection of objects, which can contain no objects (e.g., a null set, an empty set), one object, or two or more objects. The terms “engine”, “application”, “program”, “circuit” and “executable” refer to one or more sets of computer-executable instructions, in compiled or executable form, that are stored on non-transitory computer-readable media and can be executed by one or more processors to perform software- and/or hardware-based computer operations. The computer-executable instructions can be special-purpose computer-executable instructions to perform a specific set of operations, as defined by parametrized functions, specific configuration settings, special-purpose code, and/or the like. Engines, applications, programs and executables can generate and/or receive various signals, which can be transmitted in the form of electronic messages.

### Signal Control Ecosystem

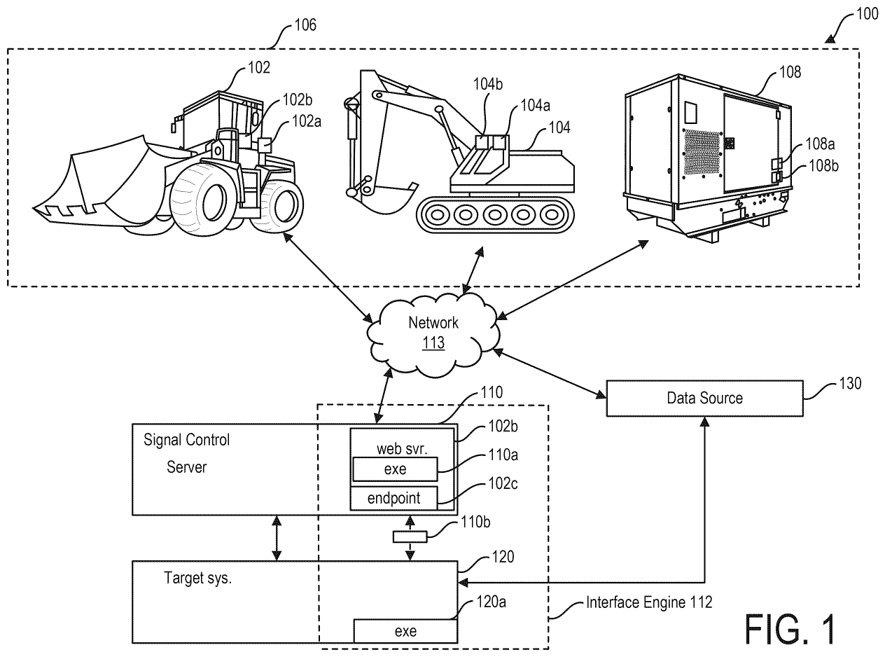

FIG. 1 shows an example signal control ecosystem 100 for industrial equipment signaling. In operation, the one or more units of industrial equipment (102, 104, 108) can generate operating data captured by various sensors (102a, 104a, 108a). The operating data can be transmitted, via the network 113, to one or more signal control servers 110, which can generate API messages 110b to transmit the operating data, in original or modified form, to various target computing system(s) 120. The target computing system(s) 120 can use the received data as training data (e.g., for AI/ML systems), for analytics relating to operating conditions of the industrial equipment (102, 104, 108), for downstream signal processing (safety monitoring, fleet monitoring, component monitoring, remote operation) and so forth.

One or more types of industrial equipment (102, 104, 108) can be included in a particular fleet 106. The industrial equipment (102, 104, 108) in the particular fleet 106 can be associated with one or more original equipment manufacturers (OEM). The industrial equipment (102, 104, 108) can include various mobile machinery items, such as earth moving machinery, mobile construction machinery and so forth, which perform various tasks, such as excavation, loading, transportation, drilling, spreading, compacting, and/or trenching of earth, rock and other materials and can be deployed for work on roads, in quarries, in mines and so forth. Accordingly, the industrial equipment (102, 104, 108) can include dozers, loaders (swing loaders, skid-steer loaders, backhoe loaders, and so forth), excavators, trenchers, dumpers, scrapers, graders, landfill compactors, rollers, pipelayers, drills, tool carriers, drainage pipe layers, ploughs, mixers (e.g., concrete mixers) and so forth. The industrial equipment (102, 104, 108) can be individual machines or combinations of devices (e.g., combinations of base machines and equipment or attachments, such as augers, buckets, blades, tillers, forks, rakes, trenchers, shears, compactors, pulverizers, and so forth) where the combinations can be identified by a product identification number (PIN), machine serial number, or another identifier. According to various implementations, the industrial equipment (102, 104, 108) can be direct-controlled devices (e.g., devices controlled by an operator in physical contact with the device) and/or self-propelled devices. The industrial equipment (102, 104, 108) can be ride-on devices, non-riding direct-controlled devices, non-riding remote controlled devices, mobile remote-controlled devices, and so forth. The industrial equipment (102, 104, 108) can further include generators or gensets (generator sets, which can include engines that drive generators that can provide power used to run other equipment). The industrial equipment (102, 104, 108) can be wire-controlled and/or wireless-controlled.

In some implementations, the industrial equipment (102, 104, 108) can be operated, controlled, and/or configured remotely, using a graphical user interface generated and displayed at the target computing system 120. The interface can allow an operator to control the industrial equipment from a distance using a remote control device. For example, for excavators, the operator can control the movement of the excavator, including the rotation, boom, and bucket functions, using a handheld remote control unit.

Industrial equipment (102, 104, 108) generate and report various items of information. To generate and report the information, industrial equipment (102, 104, 108) can each include a set of sensors (102a, 104a, 108a) and a set of controllers (102b, 104b, 108b). The sensors (102a, 104a, 108a) are configured to enable monitoring a variety of operating conditions, including real-time operating conditions of the industrial equipment (102, 104, 108) and real-time operating conditions for industrial equipment components (e.g., engine, attachments, surroundings, operating environment and so forth). The sensors (102a, 104a, 108a) can collect operating data, which is transmitted by the controllers (102b, 104b, 108b), via the network 113, to one or more signal control servers 110. The network 113 can operate according to one or more wired or wireless protocols, such as Wi-Fi, cellular, radio, satellite, Bluetooth, ZigBee, etc. To enable transmission of data and traffic management, the network 113 can include connectivity equipment, such as modems, Bluetooth transceivers, Bluetooth beacons, RFID transceivers, NFC transmitters, and the like. In some implementations, the network 113 can include a controller area network (CAN) of a particular industrial equipment (102, 104, 108).

The sensors (102a, 104a, 108a) can provide analog readings and/or digital readings. The information provided by the sensors can be used to perform on-board and/or remote diagnostics of the industrial equipment (102, 104, 108) and can relate to various operating parameters of the industrial equipment (102, 104, 108). According to various implementations, the sensors (102a, 104a, 108a) can include radar components, lidar components, cameras, ultrasonic devices, GPSs (global positioning systems) and/or other suitable components. The sensors can include components that provide two-dimensional (2D) or three-dimensional (3D) maps, readings, or information. For example, a sensor can include a camera capable of capturing light and/or other electromagnetic radiation through pixels (e.g., as in the case of a charge-couple device (CCD)). For example, a sensor can include a 2D arrangement of pixels (e.g., “cells”), each of which is capable of recording one or more signals (e.g., associated with photons of a particular range of wavelengths). In some implementations, the industrial equipment can include multiple such sensors, thereby enabling the signal evaluation platform to generate a 3D mapping of objects in the vicinity of the industrial equipment. In some implementations, sensors (102a, 104a, 108a) can provide on-demand and/or periodic readings regarding engine-out exhaust gas temperature, NOx levels, speed, engine torque, industrial equipment (102, 104, 108) positioning, temperature (e.g., coolant temperature, intake air temperature, exhaust gas temperature), oil pressure, tire pressure, load measurement, fuel consumption, and so forth. The sensors (102a, 104a, 108a) can also provide indications of operator engagement with or actuation (including automatic/autonomous actuation) of various components of the industrial equipment (102, 104, 108), such as steering wheel, attachment positioning levers, acceleration pedals, and so forth. Gensets 108 can include sensors 108a that can provide measures of power output, such as voltage, amperage, and/or real power output (measured in kilowatts (KW) per hour).

The controllers (102b, 104b, 108b) can activate, operate, and/or control sensors (102a, 104a, 108a), fuse (stitch together, aggregate) the readings of multiple sensors (102a, 104a, 108a), convert analog values to digital values, generate electronic messages containing sensor readings, and/or transmit sensor readings, via the network 113, to one or more signal control servers 110. The controllers (102b, 104b, 108b) can include hardware and/or software circuitry and can be associated with particular components of industrial equipment (102, 104, 108). For instance, controllers (102b, 104b, 108b) can include engine control units (ECUs) that control engine operations. In other examples, controllers (102b, 104b, 108b) can include powertrain control modules (PCMs), brake control modules (BCMs), door control units (DCUs), speed control units (SCUs), transmission control modules (TCMs), battery management systems (BCMs), telematics control units (TCUs), and so forth.

An example controller (102b, 104b, 108b) can be an electronic controller. The elements of an electronic controller (102b, 104b, 108b) can include, for instance, a processor/microcontroller, memory (e.g., SRAM, EEPROM, Flash), input devices (supply voltage and ground, digital input devices, analog input devices), output devices (actuator drivers, such as injectors, relays, valves), logic outputs, communication circuitry and equipment (CAN transceivers, Ethernet transceivers, including wired and wireless communication components), and various embedded software modules (boot loaders, metadata, configuration data). Accordingly, in some implementations, controllers (102b, 104b, 108b) can be structurally and/or communicatively integrated with sensors (102a, 104a, 108a). For instance, in an example where a particular controller (102b, 104b, 108b) is a TCU structured to collect, pre-process, and/or transmit signal control data, the controller (102b, 104b, 108b) can include a navigation unit (sensor (102a, 104a, 108a) that keeps track of the latitude and longitude of the industrial equipment (102, 104, 108)), a mobile communication transceiver (e.g., GSM, GPRS, Wi-Fi, WiMax, LTE or 5G), a memory, a processor, and/or a battery module and/or another power source (e.g., an interface to the power system of the industrial equipment (102, 104, 108)).

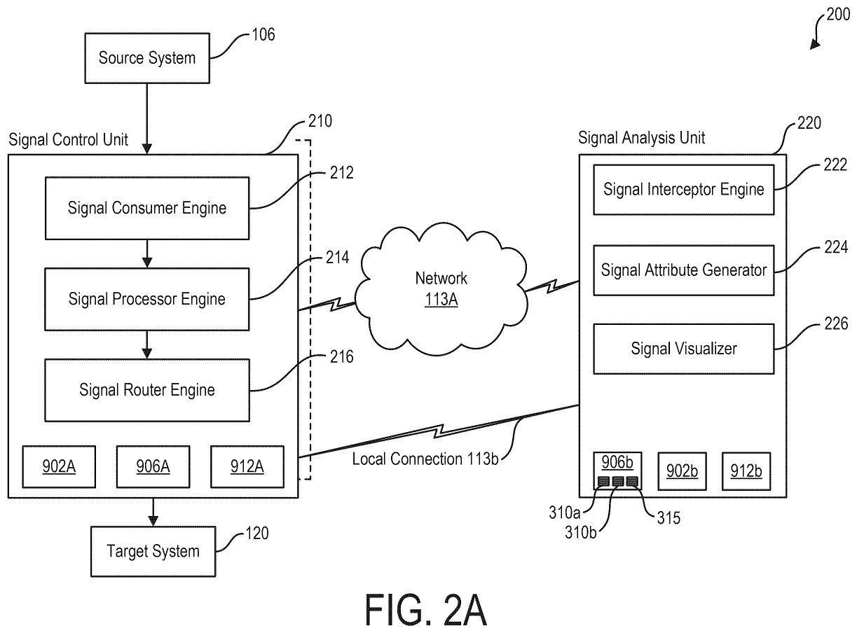

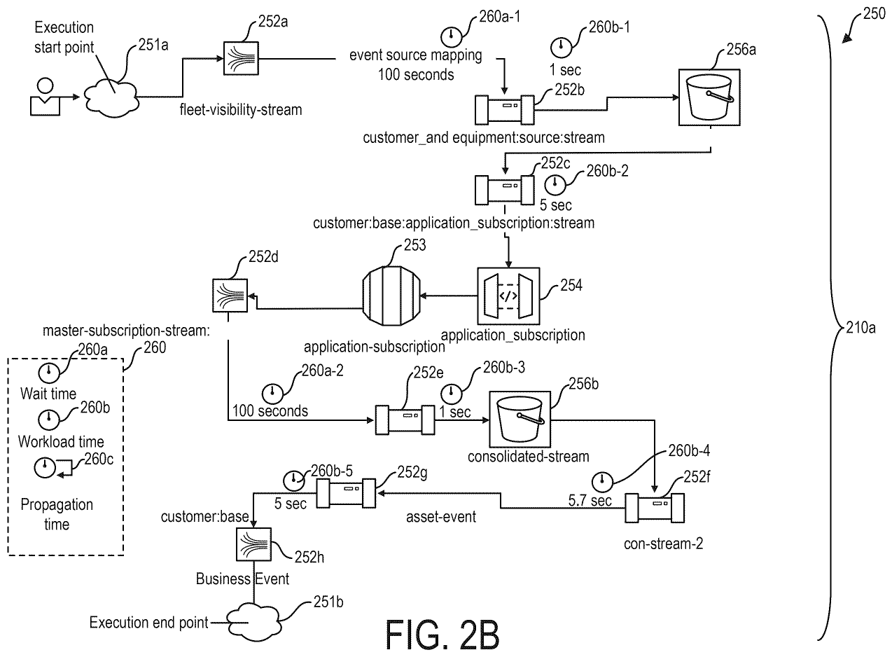

In signal control applications for industrial equipment, edge computing techniques can offer a technical advantage of offloading complex processing tasks to edge computing systems in networks of computing systems, where the edge computing systems can pre-process sensor data for transmission to downstream systems, such as the signal control server 110 and/or target computing system 120. In some implementations, the latency detection techniques described herein (e.g., using the graphs generated by signal analysis units of FIG. 2) can be utilized to optimize edge computing techniques to reduce workload time latency at controllers (102b, 104b, 108b) and/or signal control servers 110. For example, edge computing techniques can reduce the size of data transmissions and optimize network traffic. More specifically, edge computing techniques can optimize the use of transmission media bandwidth, increase the informational value of transmitted data, and/or increase the overall information throughput on a particular network. To that end, controllers (102b, 104b, 108b) can include edge computing features and can pre-process data from sensors (102a, 104a, 108a) by, for example, generating data averages, discarding data outliers, discarding repeated sensor data via periodic sampling, and so forth. In some implementations, parameters for pre-processing sensor data can be configured in response to identifying unacceptable latency levels (e.g., over a predetermined threshold) at certain nodes. For example, sensor sampling intervals, sensor reading outlier settings, sensor reading aggregation settings, and/or other parameters can be configurable to reduce latency.

In some implementations, the controllers (102b, 104b, 108b) can provide raw sensor data to the signal control server 110, which can perform edge computing operations by the executable 110a prior to transmitting the sensor data to the target computing system(s) 120. In some implementations, the controllers (102b, 104b, 108b) are integrated with the signal control server 110. For example, the controllers (102b, 104b, 108b) can include the executable 110a, and/or multiple executables 110a can be distributed across a particular controller (102b, 104b, 108b) and signal control server 110. In some implementations, the operations described herein can be performed, in whole or in part, at the controllers (102b, 104b, 108b).

In some implementations, the signal control server 110 can perform additional (e.g., increased-complexity) edge operations, such as generating virtual sensor values using information provided by multiple types of sensors (102a, 104a, 108a). The executable 110a at the signal control server 110 can include a fusion engine that can combine information from various sensors. For example, the executable 110a can combine raw reflection data from lidar, radar, and/or ultrasonic sensors (102a, 104a, 108a) with raw frame data from camera sensors (102a, 104a, 108a) and/or additional data to more accurately estimate a distance from a particular surface point on the industrial equipment (102, 104, 108) or its attachment to the object photographed by the camera. In some examples, the additional data can be collected by a set of inertial movement unit (IMU) sensors (102a, 104a, 108a) and can include, for example, multi-axial acceleration data collected via accelerometer(s) of the IMU and/or multi-axial velocity data collected via gyroscope(s) of the IMU. In some examples, the additional data can include multi-axial translational movement data (surge, heave, sway), multi-axial rotational movement data (roll, pitch, yaw) and so forth. The sensors (102a, 104a, 108a) can be mounted at suitable surface points or joints of industrial equipment (102, 104, 108) or attachments to enable collection of these types of data. As another example, the executable 110a can utilize generator 108 raw data (voltage, amperage) and/or lookup tables (e.g., power rating) to calculate power output in kilowatts per unit of time.

In some implementations, instead of or in addition to performing edge operations, the signal control server 110 can collect, via the controller (102b, 104b, 108b), raw or preprocessed sensor readings. Using raw or preprocessed sensor (102a, 104a, 108a) data, the signal control server 110 can generate electronic API messages 110b and transmit the electronic API messages 110b to target computing system(s) 120. In some implementations, the latency detection techniques described herein (e.g., using the graphs generated by signal analysis units of FIG. 2) can be utilized to optimize the edge computing techniques to reduce propagation latency at controllers (102b, 104b, 108b) and/or signal control servers 110.

The target computing system(s) 120 can include various executables 120a structured to enable management and analytics of data about the industrial equipment (102, 104, 108). For example, the executables 120a can enable remote control of industrial equipment or components thereon, sensor monitoring, safety monitoring, real-time or substantially real-time communication, detection of operating conditions, monitoring of mileage, monitoring of fuel consumption, monitoring of weather conditions, wear and tear monitoring, load monitoring and so forth. The executables 120a use specific types of data to perform their intended tasks. Therefore, the API messages 110b can include sensor data and/or additional data that augments or supplements the sensor data. For example, the API messages 110b (or data collected by the target computing system(s) 120 through other channels) can include service records for industrial equipment (102, 104, 108), complaint, defect, and/or recall records for industrial equipment (102, 104, 108), part replacement history for industrial equipment (102, 104, 108) including part identifiers, and so forth. In some implementations, the target computing system(s) 120 can receive, via API messages 110b or otherwise, additional data, such as weather condition data, road traffic monitoring data, road condition monitoring data, elevation data, location data, map data, and so forth. The additional data can be retrieved (e.g., in an API call, through a query, through a dataset or file importation process) or received (e.g., in a targeted or broadcast message) from one or more additional data sources 130.

The API messages 110b can be generated by the interface engine 112, which can include one or more web servers/web services engines, one or more endpoints 102c, and/or one or more executables (110a, 120a). The API messages 110b can be structured according to a standard (e.g., ISO-15143 or similar) that enables computing systems to exchange signal control data. The API messages 110b can include collections of addressable data elements, which can be structured as delimited records (e.g., comma-delimited, semicolon-delimited, space-delimited, and so forth), key-value pairs or nested key-value pairs (e.g., .json), labeled or tagged data or nested labeled/tagged data (e.g., .xml), and/or tabular data (e.g., SQL datasets, Excel datasets, and so forth).

In some implementations, executables 120a at target computing system(s) 120 can obtain, update and/or otherwise interact with the data resources in the API messages 110b by causing computer-executable commands to be executed and transmitted via a communication channel, such as http, https, and so forth. Accordingly, the signal control server 110, target computing system 120, and/or computing systems described further herein can be identified by a uniform resource locator (URL), and the computer-executable commands can include http operations, such as post (i.e., to create an item at the specified destination), get (i.e. to read an item from a specified destination), put or patch (i.e. to update a portion of an item in the specified destination), and/or delete (i.e. to delete an item in a specified destination).

A particular API message 110b can include the attributes sufficient to generate a particular unit of information about the industrial equipment (102, 104, 108). The units of information can be provided by a set of corresponding API endpoints 102c (locations where the interface engine 112 receives requests for specific resources) at the web server. Example units of information, also referred to as API resources, can include snapshot information (e.g., fleet snapshot, equipment status snapshot) and/or time series information (e.g., fault code time series, time series of sensor readings, attachment status time series, sensor image time series). API messages 110b can include timestamps. Fault code time series can include items such as fault code identifiers, descriptions, severity, source systems, reported dates/times and so forth. Location time series can include items such as latitude, longitude, altitude, date/time and so forth. Switch status time series, attachment status time series, and/or engine condition time series can include items such as industrial equipment on/off status, part number (e.g., engine number, switch number, attachment part identifier), date time, and so forth. The operating hours time series, idle operating hours time series, fuel used time series, and/or remaining fuel time series can include items such as value, date/time and so forth. Various additional time series data, such as distance, fuel remaining (e.g., value, percentage), diesel exhaust fluid remaining (e.g., value, percentage) and so forth can be included.

Various communication arrangements are contemplated herein. For example, in some implementations, the signal control server 110 and/or the web server 102b of the signal control server 110 can be bypassed, and the target system 120 can receive electronic messages directly from the industrial equipment (102, 104, 108). For example, the target system 120 can include a diagnostic and/or monitoring application that can be communicatively coupled to components of the industrial equipment (e.g., ECU, CAN, other industrial equipment controllers, industrial equipment sensors). As another example, the signal control server 110 and/or the web server 102b of the signal control server 110 can be bypassed when the target system 120 obtains additional data from the additional data source 130, and the target system 120 can communicate directly with the additional data source 130. As yet another example, the target system 120 can be one of a plurality of target systems, where each target system is configured to receive information from a particular fleet 106 or a subset of industrial equipment in a fleet 106 (e.g., where the target systems 120 are associated with specific dealers for a particular OEM). As yet another example, the target system 120 can be configured to receive and process data from a plurality of signal control servers 110 or industrial equipment in fleets 106 (e.g., where the target system 120 is maintained by an entity other than a particular OEM and/or can accommodate data from a plurality of OEMs).

### Industrial Equipment Data Signaling

FIG. 2A shows an example signal control unit 210 for industrial equipment signaling and an example signal analysis unit 220 for event-driven large-system analysis.

The signal control unit 210 can ingest, process, transform, generate, and/or route industrial equipment signals to target system(s) 120. In an example implementation, the signal control unit 210 can include one or more processor units 902a, one or more memory units 906a, and one or more network interfaces 912a. According to various implementations, the signal control unit 210 can be a singular system or a collection of distributed systems that can house any suitable combination of the one or more processor units 902a, one or more memory units 906a, and/or one or more network interfaces 912a. These components can implement the signal consumer engine 212, signal processor engine 214, and/or signal router engine 216. The signal consumer engine 212 can ingest incoming signals by receiving and/or subscribing to inbound signals. The signal processor engine 214 can transform, modify, and/or fuse signals or generate synthetic signals. The signal router engine 216 can transmit the signals to downstream components or systems.

In an example, a particular signal control unit 210 can include or be communicatively coupled to one or more sensors (102a, 104a, 108a), controllers (102b, 104b, 108b), and/or signal control servers 110. For instance, a particular controller (102b, 104b, 108b) and/or signal control server 110, or components thereof, can function, in various combinations, as the signal consumer engine 212, signal processor engine 214, and/or signal router engine 216.

Signal control units 210 can connect, via the network 113a, local connection 113b, or a combination thereof, to one or more signal analysis units 220. The signal analysis unit 220 can intercept industrial equipment signals, generate attributes therefor (e.g., by extracting or determining payload and/or metadata values), and generate graphs to visualize and navigate system components that correspond to the signal attributes. To that end, an example signal analysis unit 220 can include one or more processor units 902b, one or more memory units 906b, and one or more network interfaces 912b.

According to various implementations, the signal analysis unit 210 can be a singular system or a collection of distributed systems that can house any suitable combination of the one or more processor units 902b, one or more memory units 906b, and/or one or more network interfaces 912b. These components can implement the signal consumer interceptor engine 222, signal attribute generator 224, and/or signal visualizer 226.

In some implementations, the one or more processor units 902a and 902b are the same processor units or overlap at least in part. For example, the engines of the signal analysis unit 220 can include computer-executable instructions hosted or executed by any of the suitable components of the signal control unit 210 (controller (102b, 104b, 108b), signal processing server 110). In some implementations, the one or more memory units 906b include one or more physical or virtual memory cells also included in the one or more memory units 906a. For example, the engines of the signal analysis unit 220 can include or reference shared or dedicated memory locations also accessible to the controller (102b, 104b, 108b) and/or signal processing server 110. In some implementations, the engines of the signal analysis unit 220 can include dedicated short- or long-term memory units 906b. The memory units 906b can implement buffers (e.g., queues) to store copies of intercepted signals, extracted or generated signal attributes, generated synthetic signals, and/or graph representations thereof. For example, a particular one or more memory units 906b can store a set of graph nodes (310a, 310b) in which the extracted or generated signal attributes are encoded. The nodes (310a, 310b) can be stored in association with edges 315, which can have additional attributes, such as edge weight and directionality. Directionality of the particular edge 315 can be determined by recording or generating identifiers for the source system 106 (e.g., sensors of a particular industrial machine or another source computing system) and target system 120. The identifiers can include IP addresses, MAC addresses, asset identifiers, component identifiers, manufacturer identifiers or any other suitable identifiers sufficient to identify a connected entity that generated or routed a signal.

In an example use case involving the signal control unit 210 working in conjunction with the signal analysis unit 210, the signal consumer engine 212 can receive sensor data. The signal consumer engine 212 can execute or cause to be executed computer-executable instructions that embody the signal interceptor engine 224. The signal interceptor engine 224 can store a copy of the signal or its components or derivatives (e.g., items generated based on the signal by the signal processor engine 214) in buffer memory 906b. The stored item(s) can be utilized by the signal attribute generator 224 to extract or generate signal attributes, such as payload (e.g., sensor values, signal values) and metadata (e.g., signal address information, signal routing information, signal control information, signal sequencing information). The signal visualizer 226 can access or receive a copy of the signal attributes from the buffer memory 906b to generate and store graph components (nodes, edges, graphs, graph component identifiers, graph component attributes). The signal visualizer 226 can also generate signal visualizations, such as the signal control interfaces described herein.

FIG. 2B shows, in flow diagram 250, example sources of latency in a multi-hop signal control unit 210a. The signal analysis techniques described herein can be utilized to determine, with precision, sources of latency in signal processing pipelines, including, for example, wait time latency, workload time latency, propagation latency, and/or queuing latency. For example, wait time latency 260a can be determined using timestamping for the ingress and egress operations for a particular signal at a node. Workload time latency 260b can be determined using timestamping for the beginning and end of a particular operation that spans one or more nodes and one or more signals, such as signals processed by executing one or more units of computer-executable code. Propagation latency 260c can be determined using timestamping for request/response operations and/or by generating time series sequences of datapoints as signals or their derivatives propagate throughout a system (e.g., through an example physical event channel, such as from sensor (102a, 104a, 108a) to controller (102b, 104b, 108b), to signal control server 110, to the target computing system 120 of FIG. 1). Queuing latency can be determined using signal counts, signal volume per unit of time at ingress/egress buffers of a node, average in-queue time across signals, and so forth.

The sources of latency can be traced to identifiable components of the signal processing pipeline, such as the pipeline of the signal control unit 210a. Such components can include sensors or sets of sensors, event (sensor) types, on-board controllers or sets of controllers, industrial equipment objects (assets) or object types, domains (e.g., collections of IP addresses), signal processing servers, ingress queues therefor, egress queues therefor, and/or communication pathways therebetween).

In an example use case of FIG. 2B, a computing system associated with the execution end point 251b can be a customer fleet monitoring system that enables equipment monitoring across deployment sites. At execution start point 251a, a source system (e.g., a fleet management system, such as signal control server 110 that can receive control signals and sensor data from a set of industrial equipment assets in a customer's fleet at a particular location) can generate and transmit a fleet visibility stream 252a. The fleet visibility stream 252a can be ingested by downstream computing system(s) to map assets (102, 104, 108) to a particular customer deployment site. In operation, the executable(s) that collect sensor readings to determine asset operating states at the deployment site and then perform the mapping (e.g., executables 110a, 120a) can incur wait time latency (260a-1) and/or workload time latency (260b-1) as the executables perform their respective operations. The executables can generate a customer visibility stream 256a, which can be subscribed to by a particular application 254 (e.g., a customer fleet management application). The generation and transmittal of signals in the customer visibility stream 256a can incur a latency 260b-2 as the stream generated by the particular application 254 is consolidated with another data stream (e.g., from a second application 254, which can offer visibility into another data stream, such as a data stream generated by set of machines at another geographical location/deployment site associated with the customer). The consolidated data streams can form the master application stream 252d, which can, in turn, be broadcast or transmitted to a set of administrator nodes for a master application (e.g., entities or computing systems authorized to view customer fleet across locations), and so forth.

As shown, the data consolidation, aggregation, and/or transformation operations for entities in the path between the execution start point 251a at the source computing system and the execution end point 251b at the target computing system incur various types of latency at each hop. It is desirable to understand and aggregate these values across the ecosystem 210a to determine actual (aggregate) response latency incurred between the execution start point 251a and execution end point 251a. Furthermore, in some use cases, the execution start point 251a can include or precede operations performed at on-board controllers (102b, 104b, 108b), which can result in additional latency. For example, the controllers can incur wait time latency by periodically polling connected sensors and waiting for sensor responses and/or incur workload time latency by referencing sensor tables to determine a sensor to poll from a set of redundant sensors. Being able to identify the specific source of a particular type of latency enables efficient use of the related equipment, including sensor redundancy planning, controller component redundancy planning, queuing settings for sensor readings (e.g., at ingress buffers of controllers or servers), queuing settings for downstream systems, and so forth.

### Example Signal Control Interfaces of the Signal Analysis Unit 220

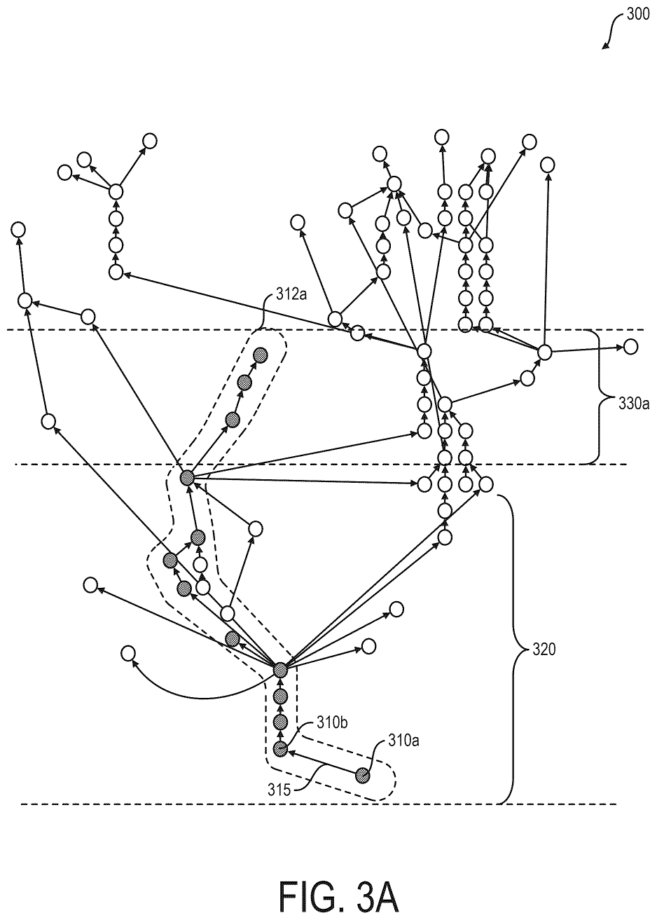

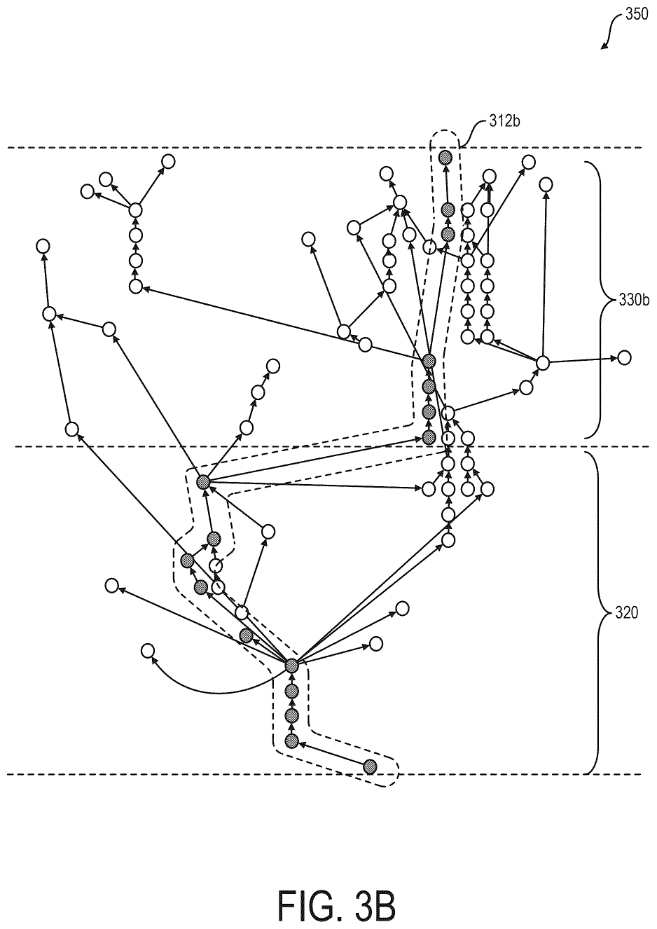

FIGS. 3A and 3B show example signal control graphs (300 and 350, respectively) generated by an example signal analysis unit 220 of FIG. 2. Generally, a particular first signal control graph 300 can include a set of nodes connected via edges. For example, nodes 310a and 310b can be connected via the edge 315. As shown, the first signal control graph 300 is a digraph such that the edges 315 capture directionality in signal flow. For instance, a particular signal can originate at node 310a and propagate to node 310b.

In systems that implement load balancing such that a particular node can route a signal via more than one downstream nodes, the ability to determine an actual signal path across the ecosystem enables optimization of signal control components, such as routing tables and executables. Accordingly, the signal control graphs (300, 350) can enable optimization of node utilization levels for load balancing. To that end, the first signal control graph 300 and the second signal control graph 350 are shown to include paths (execution pipeline segments, such as path 320) that include the same set of nodes. That is, the first signal or set of signals, visualized in the first signal control graph 300, and the second signal or set of signals, visualized in the second signal control graph 350, propagate along the same set of nodes (310a, 310b) sequenced in the same way to form the path 320. Paths 330a and 330b of the signal control graphs (300, 350) are shown to be different—that is, these paths have at least some non-overlapping nodes (312a, 312b).

In an example use case, a particular sensor 102a, represented by the node 310a, can generate a first signal at at first time T1 and a second signal at a second time T2. The on-board or off-board controller can transmit the first signal and the second signal to a particular signal control server 110, represented by the node 310b, via a communication channel represented by the edge 315. The signal control server 110 can apply routing logic to each of the first signal and the second signal, which can send the signals along the same or different paths (330a, 330b). The ability to identify such paths can enable troubleshooting of the routing logic at the signal control server 110. For example, in some use cases, the signal control server 110 can be expected to route the signals to different destinations based, for example, on signal values (e.g., a comparison of sensor readings to thresholds). In some use cases, the signal control server 110 can be expected to uniformly distribute the load by routing approximately 50% of the signals to path 330a and the remainder to path 330b. In some use cases, signal loss or attenuation can be detected by comparing signal volumes at paths 330a and/or 330b to the signal volume at path 320. In some use cases, as discussed further herein, signal propagation times along the paths 330a and 330b are expected to be substantially similar, and detecting that an average difference in signal propagation time along these paths exceeds a predetermined threshold can be cause to investigate and reduce latencies along each respective path. Once traced to identifiable components, latencies can be reduced by data streamlining to minimize the handling of unnecessary data (e.g., forgoing transmissions of redundant sensor values), by data preprocessing, by fusing sensor values, and/or by adjusting queuing parameters.

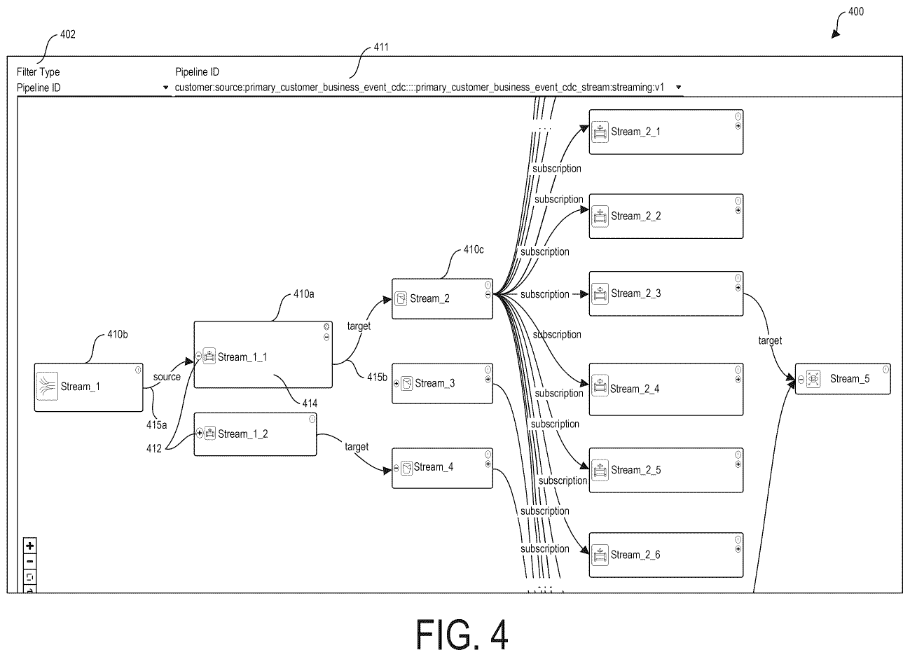

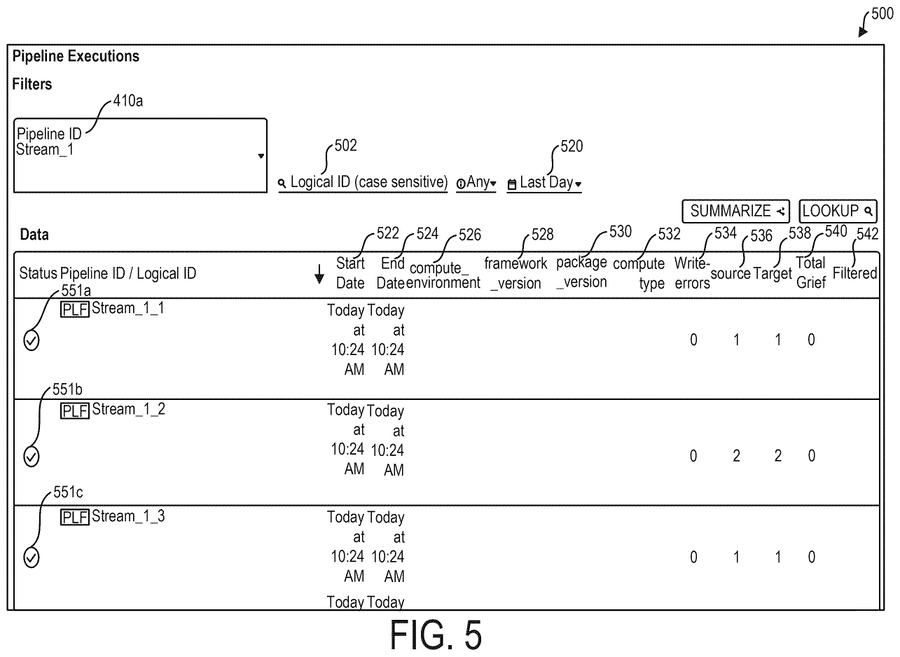

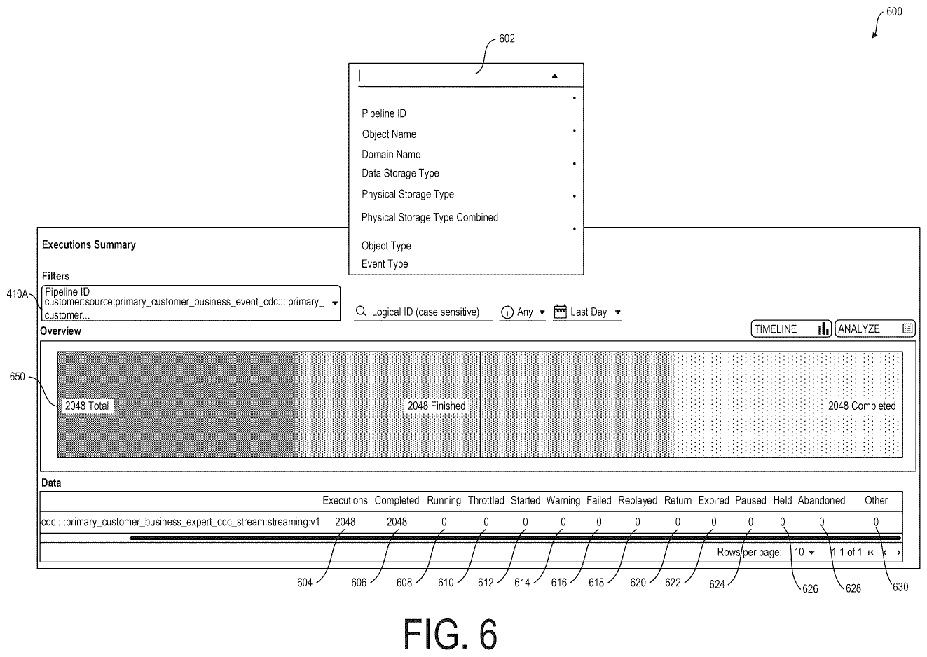

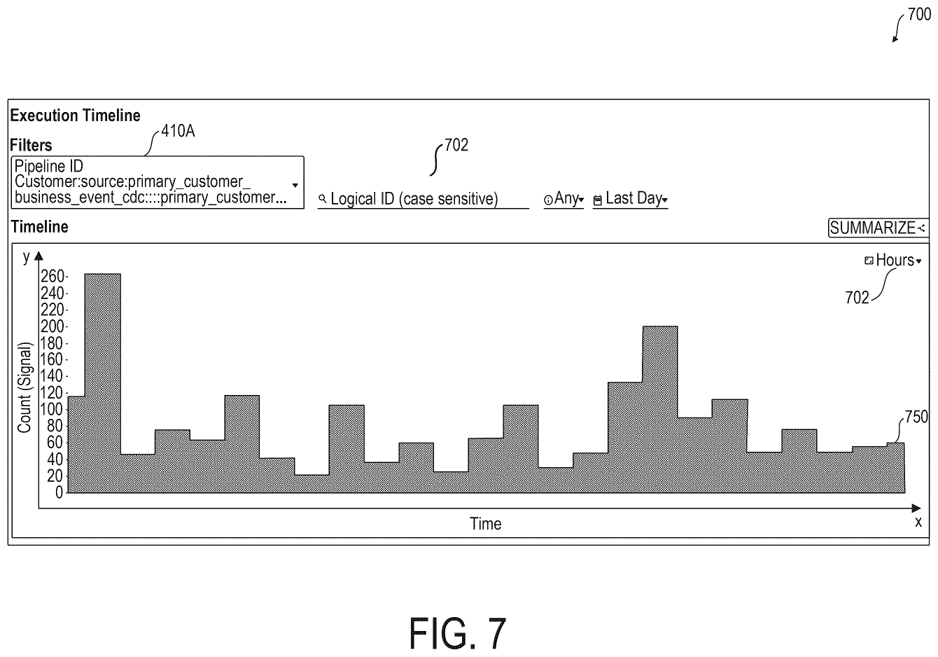

FIG. 4 shows an example set of expandable nodes (410a, 410b, 410c) and edges (415a, 415b) in a signal control graph 400. FIGS. 5, 6, and 7 show example user interfaces (500, 600, 700) accessible using interactive components of the signal control graph 400.

As shown, the signal control graph 400 is generated to be displayable on a graphical user interface that can include a control for a filter (402, 502, 602, 702). The filter (402, 502, 602, 702) can enable filtering by pipeline 411 to visualize a particular signal execution path and its branches. Additionally or alternatively, the filter (402, 502, 602, 702) can enable interactive visualization operations for sets of signals. For example, signals can be grouped by object identifiers that correspond to particular system components, such as sensors, industrial equipment, fleet, target systems, customers, deployment sites and so forth. The object identifiers can include IP addresses, MAC addresses, asset identifiers, component identifiers, manufacturer identifiers or any other suitable identifiers sufficient to identify a connected entity that generated or routed a signal. For example, signals can be grouped by object type (e.g., sensor type, asset type, equipment type, customer type, application type), event type, or another suitable signal attribute.

As shown, the nodes (410a, 410b, 410c) and/or edges (415a, 415b) in the signal control graph 400 can be interactive (e.g., via the expand/collapse control 412 or via another suitable control or gesture detection mechanism). In some implementations, the edges (415a, 415b) can be visually emphasized based on the signal volume, per unit of time, that flows along a particular edge. For example, a display property, such as the color, shading, or relative thicknesses of lines or outlines of displayable components that represent the edges can be automatically set to values selected from a range (e.g., 0-100). Various additional examples of display properties can include shapes, polygons (e.g., quantity of edges and vertices in a shape), icons, animations, text, graphical elements, or combinations of the above. A particular selected value can scale or map to a particular number of executions (signal throughput) represented by the edge. In some implementations, the particular number of executions is a filtered set such as completed executions, running executions, and attenuated signal executions (throttled executions, executions completed with warnings, failed executions, replayed executions, expired executions, paused executions, held executions, abandoned executions, and so forth).

The nodes (410a, 410b, 410c) can be expandable to reveal details of pipeline executions, which can include a list of attributes generated or determined for particular executions (551a, 551b, 551c) that occurred in a unit of time 520. The attributes 414 can include node identifiers, latency values, and so forth. As shown, variants of the signal control graph 400 can aggregate execution statistics, showing counts by completion status (650) and/or per unit of time (750).

The attributes for individual executions (551a, 551b, 551c) can include start date, end date, start time, end time, compute environment, framework version, package version, compute type, write errors, source, target, total grief, filtered values, or other suitable attributes. More generally, the attributes for individual executions (551a, 551b, 551c) can include any intercepted or generated values from signal payload or metadata, where such values are sufficient to determine source, destination, latency, signal attenuation, operating condition of the related systems, or anomalies in operation of the related systems. For example, displayed counts of various execution statuses can represent signal attenuation values.

### Example Signal Control and Analysis Methods of Operation

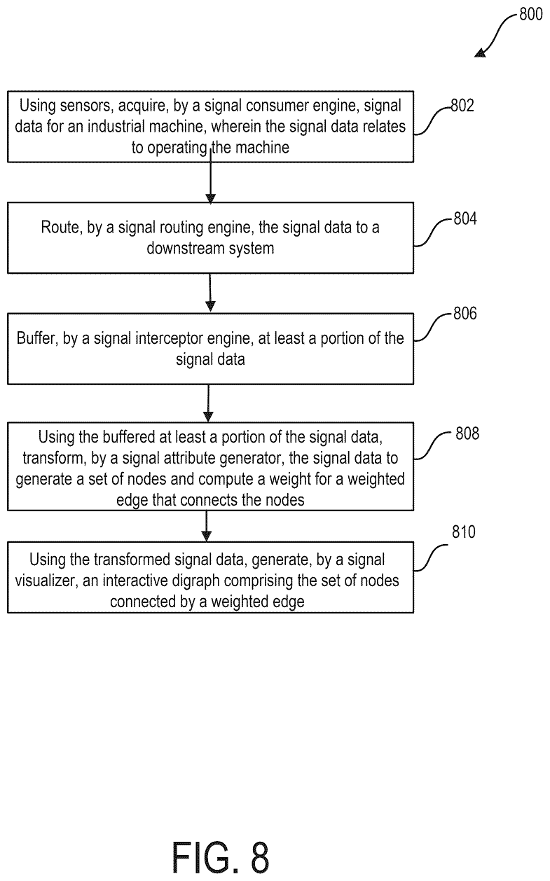

FIG. 8 is a flowchart showing a method 800 for signal control in industrial equipment. The operations of the method 800 can be performed by any suitable system or a component thereof, such as the signal control unit 210 and/or the signal analysis unit 220 of FIG. 2, the source system 106 of FIG. 2, and/or the target system 120 of FIG. 2.

In operation, at 802, a set of sensors can acquire signal data regarding a data event detected in connection with operating the industrial machine. In some implementations, instead of or in addition to being generated by sensors, the signal data can be generated by a controller (e.g., on-board or an off-board controller), signal processing server (e.g., in the form of API or other electronic messages), or another system.

At 804, the signal data can be routed to a downstream system. In some implementations, the signal data can be processed, optimized, normalized, augmented, or updated prior to being routed to the downstream system. In some implementations, additional signals or signal data can be generated and routed to the downstream system.

At 806, the system can buffer at least a portion of the signal data in memory. In some implementations, the buffer can be cache memory or another type of short-term memory. In some implementations, the buffer can include long-term memory. In some implementations, the signal data can include multiple signals. For example, the signal data can include first signal data and second signal data. In some implementations, the buffer can include a queue (e.g., an ordered set of signal data).

At 808, the system can utilize the buffered portion of the signal data to generate a graph including a first node and a second node. The graph can be a digraph. The nodes can be connected via a weighted edge. The first node can include a first node attribute set that identifies a source of the signal data. The second node can include a second node attribute set that identifies the downstream computing system.

The system can determine a weight of a weighted edge that connects the nodes using the buffered portion of the signal data. In some implementations, the system can determine the weight of the weighted edge by buffering at least a portion of the first signal data and the second signal data, using the buffered at least a portion of the first signal data and the second signal data, determine a signal throughput value (e.g., signal count per unit of time), and using the signal throughput value, calculate the weight of the weighted edge. In some implementations, the system can scale the determined signal throughput value to a predetermined range of values, such as 0-100 or another suitable set.

In some implementations, the system can determine a transmission status (e.g., as shown in elements 606-630) of the data signal to the downstream computing system. The system can use the transmission status calculate a signal attenuation value. include the signal attenuation value in one or more of the first node attribute set, the second node attribute set, or a weighed edge attribute set. The cause the signal attenuation value to be displayed at a graphical user interface along with the nodes and/or edges. The attenuation value can include a signal count (e.g., corresponding to a particular status), a percentage, a ratio, alphanumeric values, and so forth.

At 810, the system can generate a graph that includes the nodes and the weighted edge. The system can set a display property of the weighted edge based on the determined weight. The system can generate and display a graphical user interface comprising the directed graph, wherein the weighted edge is formatted for display according to the display property. The nodes and/or edges can be expandable such that interacting with a node displays additional edges that represent signal data flows to or from the node. In some implementations, additional information, such as latency or attenuation values is displayed, signal information is displayed, source system or sensor identifiers are displayed, and so forth.

In some implementations, the system can use the buffered portion of the signal data to calculate a latency value and include the latency value in one or more of the first node attribute set or the second node attribute set. The latency value can be displayable in response to detecting a user interaction with the at least one of the first node and the second node.

In some implementations, the system can determine, using the buffered portion of the signal data, a signal filter value (402, 502, 602, 702) and include the signal filter value in one or more of the first node attribute set, the second node attribute set, or a weighted edge attribute set.

### Example Computer Systems and Networks

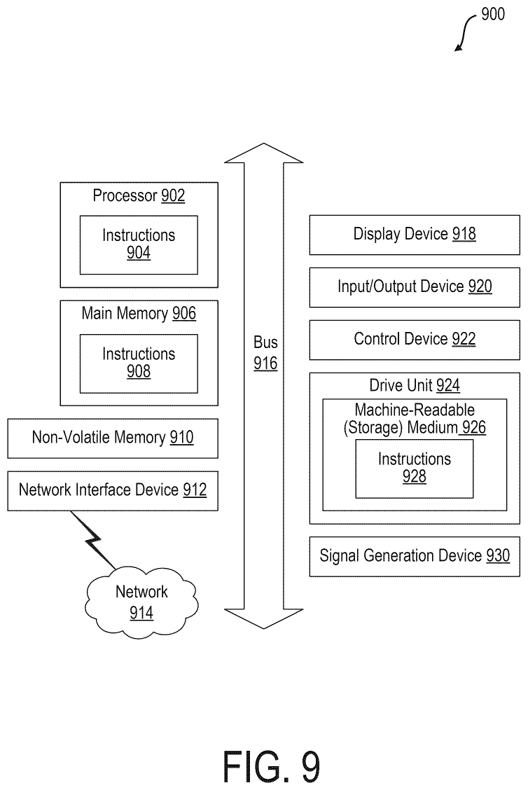

FIG. 9 is a block diagram that illustrates an example of a computer system 500 in which at least some operations described herein can be implemented. As shown, the computer system 900 can include: one or more processors 902, main memory 906, non-volatile memory 910, a network interface device 912, a display device 918, an input/output device 920, a control device 922 (e.g., keyboard and pointing device), a drive unit 924 that includes a storage medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the Figures and any other components described in this specification can be implemented.

The computer system 900 can take any suitable physical form. For example, the computer system 900 can share a similar architecture as that of a server computer, personal computer (PC), tablet computer, mobile telephone, game console, music player, wearable electronic device, network-connected (“smart”) device (e.g., a television or home assistant device), augmented reality/virtual reality (AR/VR) systems (e.g., head-mounted display), or any electronic device capable of executing a set of instructions that specify action(s) to be taken by the computer system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computer system 900 to mediate data in a network 914 with an entity that is external to the computer system 900 through any communication protocol supported by the computer system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable (storage) medium 926 can include any medium that is capable of storing, encoding, or carrying a set of instructions for execution by the computer system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computer system 900 to perform operations to execute elements involving the various aspects of the disclosure.

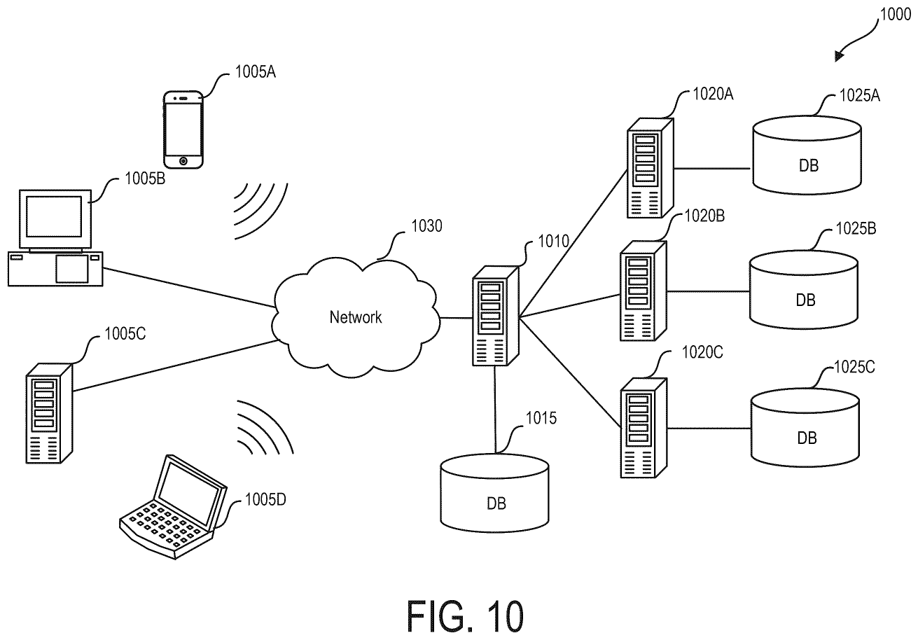

FIG. 10 is a system diagram illustrating an example of a computing environment in which the disclosed platform operates in some implementations. In some implementations, environment 1000 includes one or more client computing devices 1005A-D, examples of which can host systems described herein. Client computing devices 605 operate in a networked environment using logical connections through network 1030 to one or more remote computers, such as a server computing device.

In some implementations, server 1010 is an edge server which receives client requests and coordinates fulfillment of those requests through other servers, such as servers 620A-C. In some implementations, server computing devices 1010 and 1020 comprise computing systems, such as the signal control server 110, target system 120, signal control unit 210, signal analysis unit 220, and so forth. Though each server computing device 1010 and 1020 is displayed logically as a single server, server computing devices can each be a distributed computing environment encompassing multiple computing devices located at the same or at geographically disparate physical locations. In some implementations, each server 1020 corresponds to a group of servers.

Client computing devices 1005 and server computing devices 1010 and 1020 can each act as a server or client to other server or client devices. In some implementations, servers (1010, 1020A-C) connect to a corresponding database (1015, 1025A-C). As discussed above, each server 1020 can correspond to a group of servers, and each of these servers can share a database or can have its own database. Databases 1015 and 1025 warehouse (e.g., store) information such as signal control data, signal attributes, signal visualization data (e.g., node definitions, edge definitions), and so forth. Though databases 1015 and 1025 are displayed logically as single units, databases 1015 and 1025 can each be a distributed computing environment encompassing multiple computing devices, can be located within their corresponding server, or can be located at the same or at geographically disparate physical locations.

Network 1030 can be a local area network (LAN) or a wide area network (WAN), but can also be other wired or wireless networks. In some implementations, network 1030 is the Internet or some other public or private network. Client computing devices 1005 are connected to network 1030 through a network interface, such as by wired or wireless communication. While the connections between server 1010 and servers 1020 are shown as separate connections, these connections can be any kind of local, wide area, wired, or wireless network, including network 1030 or a separate public or private network.

### INDUSTRIAL APPLICABILITY

Systems, methods and computer-readable media are disclosed herein for event-driven large system analysis for industrial equipment signaling. For example, disclosed herein is a signal analysis unit that can include one or more memory units and circuitry that includes computer-executable instructions that can implement a signal interceptor engine. The signal interceptor engine can process industrial equipment signals to generate signal and/or routing attributes, which can be utilized to generate a graph comprising a set of nodes. The nodes, representative of signal processing pipelines, can be connected using weighted edges, which can be dynamically adjusted based on pipeline execution data, such as signal throughput.

The signal analysis techniques described herein can be utilized to determine, with precision, sources of latency in signal processing pipelines, including, for example, wait time latency, workload time latency, propagation latency, and/or queuing latency. For example, wait time latency can be determined using timestamping for the ingress and egress operations for a particular signal at a node. Workload time latency can be determined using timestamping for the beginning and end of a particular operation that spans one or more nodes and one or more signals, such as signals processed by executing one or more units of computer-executable code. Propagation latency can be determined using timestamping for request/response operations and/or by generating time series sequences of datapoints as signals or their derivatives propagate throughout a system. Queuing latency can be determined using signal counts, signal volume per unit of time at ingress/egress buffers of a node, average in-queue time across signals, and so forth.

The sources of latency can be traced to identifiable components of the signal processing pipeline. Such components can include sensors or sets of sensors, event (sensor) types, on-board controllers or sets of controllers, industrial equipment objects (assets) or object types, domains (e.g., collections of IP addresses), signal processing servers, ingress queues therefor, egress queues therefor, and/or communication pathways therebetween). Once traced to identifiable components, latency can be reduced by data streamlining to minimize the handling of unnecessary data, by data preprocessing, by fusing sensor values, and/or by adjusting queuing parameters.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A system for signal control in industrial machines, the system comprising:
a set of sensors communicatively coupled to a signal controller of an industrial machine, wherein the signal controller comprises at least one processor and at least one memory; and
one or more non-transitory, computer-readable storage media storing instructions, which, when executed by the at least one processor, cause the signal controller to:
using the set of sensors, acquire signal data regarding a data event detected in connection with operating the industrial machine;
route the signal data to a downstream computing system;
buffer at least a portion of the signal data in the at least one memory;
using the buffered portion of the signal data,
generate a graph including a first node and a second node connected via a weighted edge, wherein the first node comprises a first node attribute set that identifies a source of the signal data and the second node comprises a second node attribute set that identifies the downstream computing system and is generated using the buffered portion of the signal data;
determine a weight of the weighted edge using the buffered portion of the signal data;
set a display property of the weighted edge based on the determined weight; and
generate and display a graphical user interface comprising the graph, wherein the weighted edge is formatted for display according to the display property.

2. The system of claim 1, wherein the signal data comprises first signal data and second signal data, and wherein the instructions further cause the signal controller to determine the weight of the weighted edge by:
buffering at least a portion of the first signal data and the second signal data;
using the buffered at least a portion of the first signal data and the second signal data, determining a signal throughput value; and
using the signal throughput value, calculating the weight of the weighted edge.

3. The system of claim 2, wherein the instructions further cause the signal controller to:
scale the determined signal throughput value to a predetermined range of values.

4. The system of claim 2, wherein the instructions further cause the signal controller to:
using the buffered portion of the signal data,
determine a transmission status of the signal data to the downstream computing system;
using the transmission status, calculate a signal attenuation value;
include the signal attenuation value in one or more of the first node attribute set, the second node attribute set, or a weighed edge attribute set; and
cause the signal attenuation value to be displayed at the graphical user interface.

5. The system of claim 1, wherein at least one of the first node and the second node is expandable.

6. The system of claim 5, wherein the instructions further cause the signal controller to:
using the buffered portion of the signal data, calculate a latency value and include the latency value in one or more of the first node attribute set or the second node attribute set, wherein the latency value is displayable in response to detecting a user interaction with the at least one of the first node and the second node.

7. The system of claim 1, wherein the instructions further cause the signal controller to:
determine, using the buffered portion of the signal data, a signal filter value; and
include the signal filter value in one or more of the first node attribute set, the second node attribute set, or a weighted edge attribute set.

8. One or more non-transitory, computer-readable storage media storing instructions, which, when executed by at least one processor of a signal controller for an industrial machine, cause the signal controller to:
using a set of sensors communicatively coupled to the signal controller, acquire signal data regarding a data event detected in connection with operating the industrial machine;
route the signal data to a downstream computing system;
buffer at least a portion of the signal data in at least one memory;
using the buffered portion of the signal data,
generate a graph including a first node and a second node connected via a weighted edge, wherein the first node comprises a first node attribute set that identifies a source of the signal data and the second node comprises a second node attribute set that identifies the downstream computing system and is generated using the buffered portion of the signal data;
determine a weight of the weighted edge using the buffered portion of the signal data;
set a display property of the weighted edge based on the determined weight; and
generate and display a graphical user interface comprising the graph, wherein the weighted edge is formatted for display according to the display property.

9. The media of claim 8, wherein the signal data comprises first signal data and second signal data, and wherein the instructions further cause the signal controller to determine the weight of the weighted edge by:
buffering at least a portion of the first signal data and the second signal data;
using the buffered at least a portion of the first signal data and the second signal data, determining a signal throughput value; and
using the signal throughput value, calculating the weight of the weighted edge.

10. The media of claim 9, wherein the instructions further cause the signal controller to:
scale the determined signal throughput value to a predetermined range of values.

11. The media of claim 9, wherein the instructions further cause the signal controller to:
using the buffered portion of the signal data,
determine a transmission status of the signal data to the downstream computing system;
using the transmission status, calculate a signal attenuation value;
include the signal attenuation value in one or more of the first node attribute set, the second node attribute set, or a weighed edge attribute set; and
cause the signal attenuation value to be displayed at the graphical user interface.

12. The media of claim 8, wherein at least one of the first node and the second node is expandable.

13. The media of claim 12, wherein the instructions further cause the signal controller to:
using the buffered portion of the signal data, calculate a latency value and include the latency value in one or more of the first node attribute set or the second node attribute set, wherein the latency value is displayable in response to detecting a user interaction with the at least one of the first node and the second node.

14. The media of claim 8, wherein the instructions further cause the signal controller to:
determine, using the buffered portion of the signal data, a signal filter value; and
include the signal filter value in one or more of the first node attribute set, the second node attribute set, or a weighted edge attribute set.

15. A computer-implemented method performed by a signal controller for an industrial machine, the method comprising:
using a set of sensors communicatively coupled to the signal controller, acquiring signal data regarding a data event detected in connection with operating the industrial machine;
routing the signal data to a downstream computing system;
buffering at least a portion of the signal data in at least one memory;
using the buffered portion of the signal data,
generating a graph including a first node and a second node connected via a weighted edge, wherein the first node comprises a first node attribute set that identifies a source of the signal data and the second node comprises a second node attribute set that identifies the downstream computing system and is generated using the buffered portion of the signal data;
determining a weight of the weighted edge using the buffered portion of the signal data;
setting a display property of the weighted edge based on the determined weight; and
generating and displaying a graphical user interface comprising the graph, wherein the weighted edge is formatted for display according to the display property.

16. The method of claim 15, wherein the signal data comprises first signal data and second signal data, the method further comprising determining the weight of the weighted edge by:
buffering at least a portion of the first signal data and the second signal data;
using the buffered at least a portion of the first signal data and the second signal data, determining a signal throughput value; and
using the signal throughput value, calculating the weight of the weighted edge.

17. The method of claim 16, further comprising:
scaling the determined signal throughput value to a predetermined range of values.

18. The method of claim 16, further comprising:
using the buffered portion of the signal data,
determining a transmission status of the signal data to the downstream computing system;
using the transmission status, calculating a signal attenuation value;
including the signal attenuation value in one or more of the first node attribute set, the second node attribute set, or a weighed edge attribute set; and
causing the signal attenuation value to be displayed at the graphical user interface.

19. The method of claim 15, wherein at least one of the first node and the second node is expandable.

20. The method of claim 19, further comprising:
using the buffered portion of the signal data, calculating a latency value and include the latency value in one or more of the first node attribute set or the second node attribute set, wherein the latency value is displayable in response to detecting a user interaction with the at least one of the first node and the second node.
